(19) United States
(12) Patent Application Publication
(10) Pub. No.: US 2023/0149955 A1
(43) Pub. Date: May 18, 2023

(54) SPRAY GUN, IN PARTICULAR A PAINT SPRAY GUN

(71) Applicant: SATA GmbH & Co. KG, Kornwestheim (DE)

(72) Inventor: Norbert MAIER, Allmersbach i.T. (DE)

(73) Assignee: SATA GmbH & Co. KG, Kornwestheim (DE)

(21) Appl. No.: 17/909,142

(22) PCT Filed: Feb. 18, 2021
(86) PCT No.: PCT/EP2021/053940

§ 371 Date: Sep. 2, 2022

(30) Foreign Application Priority Data
Mar. 6, 2020 (DE) 10 2020 106 171.4

(51) Int. Cl. B05B 7/06; B05B 7/08; B05B 7/12

(52) U.S. Cl. CPC B05B 7/066; B05B 7/0815; B05B 7/1236; B05B 12/008

(57) ABSTRACT

A spray gun includes first and second air outlet channel arrangements. At least one parameter, in particular pressure, volume flow and/or flow speed of air flowing through the first arrangement and at least one parameter, in particular pressure, volume flow and/or flow speed of air flowing through the second arrangement can be controlled independently of one another in an open and/or closed loop manner. The spray gun also includes a third air outlet channel arrangement and at least one parameter, in particular pressure, volume flow and/or flow speed of air flowing through the third arrangement can be controlled in an open and/or closed loop manner independently of at least one parameter of the first arrangement, and/or independently of at least one parameter of the second arrangement. Thus, three different types of air (atomisation, shaping, and transporting) can each be controlled independently providing increased flexibility in use for different painting tasks.

The invention relates to a spray gun, in particular a paint spray gun, according to the preamble of claim 1.

Spray guns, in particular paint spray guns, operate using various pressurizing methods. Conventional spray guns operate at relatively high spray pressures of several bar. In so-called HVLP guns, the internal nozzle pressure is at most 10 psi or 0.7 bar, as a result of which transmission rates of far beyond 65% are achieved. Compliant spray guns, in turn, have an internal nozzle pressure of more than 10 psi or 0.7 bar, but likewise achieve a transmission rate of more than 65%.

The internal nozzle pressure of the spray gun is understood to mean the pressure that prevails in the air cap of the spray gun. The atomization air region here is often separated from the horn air region and a different pressure may prevail in the atomization air region than in the horn air region. However, the pressures in the atomization air region and in the horn air region may also be identical. The internal nozzle pressure can be measured with the aid of a so-called test air cap, for example. This here is a special air cap which is disposed on the spray gun instead of the customary air cap. The test air cap usually has two manometers, wherein one of the latter by way of a bore in the test air cap is connected to the atomization air region, and the other by way of a further bore in the test air cap is connected to the horn air region.

According to the prior art, a spray gun, in particular a paint spray gun, in particular a pressurized air atomization paint spray gun, on the head thereof has a paint nozzle which is screwed into the gun body. The paint nozzle on the front end thereof often has a hollow-cylindrical plug, the material to be sprayed exiting the front port of said plug during the operation of the spray gun. However, the paint nozzle in the front region thereof can also be of a conical design. The gun head usually has an external thread by way of which an annular air nozzle having an air cap disposed therein is screwed to the gun head. The air cap has a central opening with a diameter larger than the external diameter of the paint nozzle plug, or the external diameter of the front end of a conical paint nozzle, respectively.

The central opening of the air cap and the plug, or the front end of the paint nozzle, respectively, conjointly form an annular gap. The so-called atomization air, which in the nozzle assembly described above generates a negative pressure on the end face of the paint nozzle, as a result of which the material to be sprayed is suctioned out of the paint nozzle, exits this annular gap. The atomization air impinges on the paint jet, as a result of which the paint jet is shredded so as to form threads and strips. These threads and strips disintegrate by virtue of their hydrodynamic instability, the interaction between the rapidly flowing compressed air and the ambient air, as well as by virtue of aerodynamic disturbances, to form droplets which are blown away from the nozzle by the atomization air.

The air cap furthermore often has two horns which are diametrically opposed and in the outflow direction project beyond the annular gap mentioned and the material outlet opening. Two supply bores, i.e. horn air feed ducts, run from the rear side of the air cap to horn air bores in the horns. Each horn usually has at least one horn air bore; however, each horn preferably has at least two horn air bores from which the horn air exits. The horn air bores are usually oriented such that said horn air bores point toward the nozzle longitudinal axis behind the annular gap in the exiting direction, so that the so-called horn air exiting the horn air bores can influence the air that has already exited the annular gap, or the paint jet or the paint mist which has already been at least partially created, respectively. As a result, the paint jet, or else the spray jet, with an originally circular cross section (round jet) is compressed on the sides of said jet that face the horns and is elongated in the direction perpendicular thereto. Created as a result is a so-called broad jet which permits a high surface painting rate. Besides deforming the spray jet, the horn air causes further atomization of the spray jet.

Air ducts are usually incorporated in the gun body, i.e. the main body of the spray gun, wherein air from one of the ducts, as described above, for use as atomization air is directed to the annular gap mentioned, and air from another duct, as described above, for use as horn air is directed to the horn air openings mentioned. To this end, the air ducts open out in an end face of the head of the gun body and by way of an air distributor assembly are directed to the annular gap, or the horn air bores, respectively. The air distributor assembly often comprises an air distributor ring which separates the atomization air region and the horn air region from one another.

For distributing the air between the atomization air duct and the horn air duct, spray guns often have a round-broad jet control which may be designed in various ways.

DE 10 2009 032 399 A1 discloses a paint spray gun having a compressed air distributor chamber into which open an air inlet duct, an atomization air duct and a horn air duct, wherein the quantity of air fed to the air distributor chamber, the atomization air duct and the horn air duct is adjustable by way of an actuating element which is disposed in the compressed air distributor chamber and by way of an activation element disposed laterally on the gun body is rotatable from the outside about a rotation axis running through the air distributor chamber.

It is disadvantageous in this prior art that a variation of the quantity of air fed to the horn air duct is associated with a variation of the quantity of air fed to the atomization air duct. For example, when the user of the spray gun increases the quantity of air fed to the horn air duct, in particular because he/she desires a flatter spray jet, the quantity of air available to the atomization air duct is thus reduced. Conversely, a reduction of the quantity of air fed to the horn air duct leads to an increase of the quantity of air fed to the atomization air duct, which is likewise undesirable in most instances. These undesirable changes require the overall quantity of air flowing into the gun to be readjusted. The device for adjusting the overall quantity of air, for example the air micrometer, is situated at a location in the spray gun different from that of the round-broad jet control, for example at the lower end of the handle or at the rear end of the spray gun.

In order for this issue to be solved, U.S. Pat. No. 10,247,313 B2 proposes a spray gun having a first activation element and a second activation element, wherein the first activation element adjusts the atomization air, and the second activation element adjusts the horn air. The two activation elements are disposed in direct mutual proximity.

JP 2008161789 A likewise describes a powder spray gun having a first activation element 19 having a first valve member 17 and a second activation element 20 having a second valve member 18, wherein the first activation element 19 adjusts the atomization air, and the second activation element 20 adjusts the horn air. The first valve member 17 is disposed within the second valve member 18 and coaxially with the latter. The mutual friction between the valve members 17 and 18 is less than the respective friction between one valve member 17, 18 and the gun body so that the two valve members 17 and 18 can in each case be individually activated without the other valve member 17, 18 conjointly rotating. The position of the valve members 17, 18 relative to one another can be fixed by way of a fixing screw 46 so that the activation of one activation element 19, 20 generates a movement of both valve members 17, 18, as a result of which a constant ratio of atomization air to horn air can be guaranteed.

It is disadvantageous in this prior art that the only the atomization air and the horn air are separately adjustable. It is an object of the present invention to provide a spray gun which can be used in a more flexible manner for various painting jobs.

The first object is achieved by a spray gun, in particular a paint spray gun, in particular a hand-held paint spray gun, which has at least one first air outlet duct assembly and at least one second air outlet duct assembly, wherein at least one parameter, in particular a pressure, a volumetric flow and/or a flow rate, of the air flowing through the first air outlet duct assembly, and at least one parameter, in particular a pressure, a volumetric flow and/or a flow rate, of the air flowing through the second air outlet duct assembly are able to be controlled and/or feedback-controlled in a mutually independent manner, wherein the spray gun has at least one third air outlet duct assembly, and wherein at least one parameter, in particular a pressure, a volumetric flow and/or a flow rate, of the air flowing through the third air outlet duct assembly is able to be controlled and/or feedback-controlled independently of at least one parameter, in particular a pressure, a volumetric flow and/or a flow rate, of the air flowing through the first air outlet duct assembly and/or independently of at least one parameter, in particular a pressure, a volumetric flow and/or a flow rate, of the air flowing through the second air outlet duct assembly.

The spray gun can be any arbitrary type of spray gun that uses air, in particular compressed air, in particular be a pressurized air atomization spray gun which atomizes the sprayed medium by means of compressed air, or else be an air-assisted airless gun in which the sprayed medium is atomized above all in that said spray medium is forced at high pressure through a small nozzle. Air here can be used for homogenization and/or post-atomization, or else for shaping the spray jet. The spray gun can be in particular a flow-cup gun, a hanging-cup gun, a side-cup gun or a pressure-fed gun. The spray gun can in particular be designed to be used for spraying liquid media, in particular paint or lacquer, or be designed for spraying pulverulent media.

The air outlet duct assemblies can in each case be individual air ducts; however, the air outlet duct assemblies can also be assembled from a plurality of air ducts. The air ducts can be incorporated in the main body of the spray gun by drilling. The bores and thus the air ducts can meet, as a result of which bifurcations and transitions can be implemented. The air outlet duct assemblies can also be formed by a plurality of different components of the spray gun, for example by the main body of the spray gun conjointly with an add-on part. The air outlet duct assemblies can also initially run in the main body of the spray gun, then open into air outlet openings in the head region of the main body of the spray gun, and subsequently continue through other components of the spray gun, for example through an air nozzle, an air distributor assembly, or similar.

The controlling and/or feedback-controlling of the parameter or of the parameters, respectively, in particular of a pressure, a volumetric flow and/or a flow rate, of the air flowing through the first, second and/or third air outlet duct assembly can be performed mechanically, electrically, electronically and/or electromechanically. Controlling in particular can be performed by means of a simple mechanical rotary button, wherein the rotary button or a part disposed thereon mechanically engages in, for example protrudes into, the air outlet duct assembly and/or at least partially covers said air duct assembly, in particular changes the flow cross section of said air duct assembly. Control in the present case is in particular to be understood to be an analog control without feedback. An advantage of such a control lies in the simplicity of the latter, in particular in the simple and thus cost-effective construction of said control, which can also dispense with a measuring device. However, there has to be a manual response to malfunctions, for example to a drop in pressure. In contrast, a feedback control can maintain the parameters at a constant level by the system measuring the variable to be influenced, and continuously comparing said variable with the desired target value. An actuator, which can be designed as part of the feedback-control device or as a separate part, acts on the control path in such a manner that the actual value corresponds to the target value. The actuator or actuators can presently be disposed in or on the spray gun; however, said actuator or actuators can also be disposed so as to be remote from the spray gun, for example in or on an air hose, or in or on a compressor. Valves or apertures, in particular those which can be opened and closed in a preferably stepless manner, may be expedient for the present application.

A control and/or feedback-control device, particularly preferably a feedback-control device, preferably has a device for entering and/or detecting and/or displaying at least one parameter of at least one fluid flowing through the spray gun, in particular a pressure, temperature, moisture, a volumetric flow, a viscosity and/or a flow rate, or is connected to a device of this type. By way of the device for entering at least one parameter of at least one fluid flowing through the spray gun, a target value for this parameter can be established or communicated to a control and/or feedback-control device, respectively. A device for detecting a parameter measures the actual value of a parameter, in particular of the parameter for which a target value has been established, and a device for displaying a parameter displays the target value and/or the actual value of a parameter, in particular of the parameter for which a target value has been established and an actual value has been measured. The control and/or feedback-control device, particularly preferably the feedback-control device, preferably has at least one actuator or is connected to at least one actuator, so as to be able to adjust the parameter. Further explanations pertaining to the control and/or feedback-control devices are to be found further below.

The first air outlet duct assembly is preferably designed in such a manner that a spray medium is able to be atomized by means of the air guided by said first air outlet duct assembly (atomization air), the second air outlet duct assembly is preferably designed in such a manner that the shape of a spray jet is able to be changed by means of the air guided by said second air outlet duct assembly (forming air), and/or the third air outlet duct assembly is designed in such a manner that an atomized spray medium is able to be moved away from the spray gun by means of the air guided by said third air outlet duct assembly (transport air).

Besides the atomization air, by means of which a spray medium is atomized, and the horn air, which hereunder, in a manner corresponding to the primary task thereof and by virtue of the fact that said horn air does not mandatorily have to flow from horns, is referred to as forming air and by means of which the shape of a spray jet is changed, the applicant has identified a third type of air, the adjustability of which can have a positive effect on the painted result. This here is air by means of which an atomized spray medium is moved away from the spray gun, in particular in the direction of an object to be coated. This type of air is presently referred to as transport air. By means of the present invention it is possible for the atomization air, the forming air and the transport air to be in each case controlled, or feedback-controlled, respectively, in a mutually independent manner. This makes possible in particular an enhanced flexibility in terms of the use of the spray gun for different painting tasks. As a result it is in particular possible for different materials, in particular materials of dissimilar viscosity, to be sprayed using one and the same nozzle. For example, the atomization air can be turned up for higher-viscosity media, i.e. at least one parameter, in particular the pressure, the volumetric flow and/or the flow rate, of the atomization air can be increased in order to guarantee sufficient atomization of the higher-viscosity medium. The volumetric flow is often also referred to as air quantity.

Furthermore, the spray gun particularly preferably has at least one material nozzle having a material outlet opening for delivering material to be sprayed, and an air cap having a central opening and two horns having in each case at least one horn air opening, wherein an outer wall of the material nozzle, conjointly with the region of the air cap that delimits the central opening of the air cap, forms an annular gap, and wherein the air cap furthermore on at least two mutually opposite sides of the central opening, next to the central opening, has in each case at least one control opening, in particular at least two, in particular three control openings, wherein a spray medium is able to be atomized by means of the air flowing from the annular gap (atomization air), wherein the shape of a spray jet is able to be changed by means of the air flowing from the horns (forming air), and wherein an atomized spray medium is able to be moved away from the spray gun by means of the air flowing from the control openings (transport air). The design embodiment of nozzles having an annular gap, control openings and horns having horn air openings has proven successful in the prior art. By means of the present invention it is possible for the air flowing from the annular gap, the air flowing from the control openings, and the air flowing from the horn air openings to be in each case controlled or feedback-controlled, respectively, in a mutually independent manner. The advantages mentioned above can be achieved as a result.

The spray gun furthermore preferably has a material nozzle having an material outlet opening for delivering material to be sprayed and a material outlet axis along which the material to be sprayed flows out, wherein the spray gun is designed in such a manner that air for atomizing a spray medium (atomization air) upon exiting the first air outlet duct assembly impacts the material to be sprayed and exiting the material nozzle in a manner substantially parallel to the material outlet axis and/or obliquely, that air for shaping a spray jet (forming air) upon exiting the second air outlet duct assembly impacts the atomized material obliquely, and that air for transporting the atomized material in the direction of an object to be coated (transport air) upon exiting the third air outlet duct assembly impacts the atomized material in a manner substantially parallel to the material outlet axis.

The atomization air flowing from the first air outlet duct assembly can flow out in a manner substantially parallel to the material outlet axis and in the nozzle assembly described above generates a vacuum on the end face of the material nozzle, as a result of which the material to be sprayed is suctioned out of the material nozzle. The atomization air meets the paint jet, as a result of which the paint jet is shredded into threads and strips. These threads and strips disintegrate by virtue of their hydrodynamic instability, the interaction between the rapidly flowing compressed air and the ambient air, as well as by virtue of aerodynamic disturbances, so as to form droplets which are blown away from the nozzle by the atomization air. The front end of the material nozzle can be designed as a cone instead of a cylindrical plug, so that the atomization air flowing from the first air outlet duct assembly preferably impacts the material to be sprayed and exiting the material nozzle obliquely, preferably at an angle between 35° and 65°. Such a conical nozzle is used above all in pressurized cup guns, because conical nozzles often do not generate sufficient negative pressure in order for the material to be sprayed to be suctioned out of the material nozzle.

The air for shaping a spray jet, the so-called forming air, upon exiting the second air outlet duct assembly preferably impacts the atomized material obliquely. The outlets of the second air outlet duct assembly in the axial direction as well as in the radial direction are preferably a few millimeters away from the material outlet, in particular so that the forming air can spread out somewhat and impact the spray jet across a larger area and with less shock. The spray jet which originally has a circular cross section is compressed so as to form a flat jet having a more oval cross-section in particular when the forming air impacts the spray jet from two opposite sides.

The air for transporting the atomized material in the direction of an object to be coated, the so-called transport air, upon exiting the third air outlet duct assembly impacts the atomized material in a manner substantially parallel to the material outlet axis. As a result, the atomized material is effectively blown in the direction of the object to be coated. In the present case, “substantially parallel” is to be understood to include inclinations of up to 10° in the direction toward the material outlet axis and of up to 10° away from the material outlet axis.

In the spray gun according to the invention, the controlling and/or feedback-controlling of at least one parameter, in particular of a pressure, a volumetric flow and/or a flow rate, of the air flowing through the first air outlet duct assembly preferably takes place by means of a first control and/or feedback-control device, in particular a first control and/or feedback-control device disposed in the first air outlet duct assembly and/or in an air distributor region, in particular a device for changing the flow cross section of the first air outlet duct assembly, the controlling and/or feedback-controlling of at least one parameter, in particular of a pressure, a volumetric flow and/or of a flow rate, of the air flowing through the second air outlet duct assembly takes place by means of a second control and/or feedback-control device, in particular a second control and/or feedback-control device disposed in the second air outlet duct assembly and/or in an air distributor region, in particular a device for changing the flow cross section of the second air outlet duct assembly, and/or the controlling and/or feedback-controlling of at least one parameter, in particular of a pressure, a volumetric flow and/or a flow rate, of the air flowing through the third air outlet duct assembly takes place by means of a third control and/or feedback-control device, in particular a third control and/or feedback-control device disposed in the third air outlet duct assembly and/or in an air distributor region, in particular a device for changing the flow cross section of the third air outlet duct assembly.

This means that the controlling and/or feedback-controlling of at least one parameter of the air flowing through the first air outlet duct assembly takes place by means of a first control and/or feedback-control device, the controlling and/or feedback-controlling of at least one parameter of the air flowing through the second air outlet duct assembly takes place by means of a second control and/or feedback-control device, and the controlling and/or feedback-controlling of at least one parameter of the air flowing through the third air outlet duct assembly takes place by means of a third control and/or feedback-control device. The parameters can in each case be a pressure, a volumetric flow, a flow rate, or any other parameter. The first, the second and the third control and/or feedback control device preferably regulate the same type of parameter; this means that all three control and/or feedback-control devices control, or feedback-control, respectively, the volumetric flow of the air flowing through the air outlet duct assembly assigned thereto, for example. However, it is also conceivable for said control and/or feedback control devices to control, or feedback-control, respectively, different types of parameters; i.e. for example the first control and/or feedback control device controls, or feed-back controls, respectively, the pressure of the air flowing through the first air outlet duct assembly, the second control and/or feedback-control device controls, or feedback-controls, respectively, the volumetric flow of the air flowing through the second air outlet duct assembly, and the third control and/or feedback-control device controls, or feedback-controls, respectively, the flow rate of the air flowing through the third air outlet duct assembly. It is likewise conceivable for two control and/or feedback control devices to control, or feedback-control, respectively, the same type of parameter, and for the other control and/or feedback-control device to control, or feedback-control, respectively, another type of parameter.

The first control and/or feedback-control device can be disposed in the first air outlet duct assembly and/or in an air distributor region, the second control and/or feedback-control device can be disposed in the second air outlet duct assembly and/or in an air distributor region, preferably the same air distributor region as the first control and/or feedback-control device, and the third control and/or feedback-control device can be disposed in the third air outlet duct assembly and/or in an air distributor region, preferably the same air distributor region as the first and/or the second control and/or feedback-control device. The control and/or feedback-control devices can be disposed within the air outlet duct assemblies, at the start and/or at the end of the latter, i.e. also at ports of the air outlet duct assemblies. Each of the air outlet duct assemblies can have a plurality, also a plurality of different, control and/or feedback-control devices.

The first control and/or feedback-control device can be designed as a device for changing the flow cross section of the first air outlet duct assembly, the second control and/or feedback-control device can be designed as a device for changing the flow cross section of the second air outlet duct assembly, and/or the third control and/or feedback-control device can be designed as a device for changing the flow cross section of the third air outlet duct assembly. By changing the flow cross section of the air outlet duct assemblies, a few parameters of the air flowing therethrough can be adjusted, in particular controlled or feedback-controlled. The flow cross section of an air outlet duct assembly can be changed in different ways. For example, an element, for example a screw, may be able to be screwed into the air outlet duct assembly or into a single air duct so that the screw can protrude into the air outlet duct assembly or into the single air duct to a variable extent, as a result of which the flow cross section can be reduced and increased again.

Alternatively or additionally, one device, or a plurality of, the devices for changing the flow cross section can be designed like an actuating element disclosed in above-mentioned DE 10 2009 032 399 A1, or designed in a manner similar thereto.

At least one first air outlet duct assembly preferably opens into at least one first air outlet opening, at least one second air outlet duct assembly opens into at least one second air outlet opening, and at least one third air outlet duct assembly opens into at least one third air outlet opening. The air outlet openings here are mutually separated. Individual air outlet duct assemblies, or each of the air outlet duct assemblies, can open into a plurality of air outlet openings; i.e. one air outlet duct assembly can bifurcate at one location or at a plurality of locations and open into a plurality of air outlet openings, for example. The air outlet openings can have a circular cross section; this may be the case in particular when the air outlet duct assemblies have been incorporated in the spray gun by means of drilling. However, the air outlet openings may also have another cross section. In this case, said air outlet openings can be incorporated in the spray gun by means of milling, for example. It is also conceivable for the air outlet duct assemblies to be incorporated in the spray gun by means of drilling and to shape the air outlet openings in the desired manner, in particular by milling. The air outlet duct assemblies, the air outlet openings and/or the entire spray gun can be designed in an even more flexible manner when 3D-printing is used.

The spray gun according to the invention furthermore preferably has a main body having a head region, wherein the head region of the main body of the spray gun has at least one first air outlet opening, at least one second air outlet opening and/or at least one third air outlet opening. These air outlet openings here are particularly preferably the air outlet openings mentioned above. This means that at least one first air outlet duct assembly opens into at least one first air outlet opening in the head region of the main body of the spray gun, at least one second air outlet duct assembly opens into at least one second air outlet opening in the head region of the main body of the spray gun, and/or at least one third air outlet duct assembly opens into at least one third air outlet opening in the head region of the main body of the spray gun. In this case, the explanations above apply in analogous manner.

The spray gun according to the invention furthermore preferably has at least one nozzle assembly having at least one air nozzle, wherein the air nozzle has at least one first air outlet opening, in particular at least one first air outlet opening designed as a central opening in an air cap of the air nozzle, at least one second air outlet opening, in particular at least one second air outlet opening designed as a horn air opening incorporated in horns on an air cap of the air nozzle, and/or at least one third air outlet opening, in particular at least one third air outlet opening designed as a control opening in the air cap. This means that at least one first air outlet duct assembly, at least one second air outlet duct assembly and/or at least one third air outlet duct assembly open into the air nozzle of the spray gun. The ports can also be formed by different components, for example by the air nozzle conjointly with the material nozzle. The explanations above apply in analogous manner.

Furthermore, the spray gun particularly preferably has at least one air connector, in particular compressed air connector, at least one air inlet duct assembly and at least one air distributor region, wherein the air inlet duct assembly extends from the air connector to the air distributor region, wherein the first air outlet duct assembly extends from the air distributor region to at least one first air outlet opening, wherein the second air outlet duct assembly extends from the air distributor region to at least one second air outlet opening, wherein the third air outlet duct assembly extends from the air distributor region to at least one third air outlet opening, and wherein the first air outlet duct assembly, the second air outlet duct assembly and the third air outlet duct assembly are mutually separated in spatial terms. The air distributor region is particularly preferably the air distributor region already mentioned above.

The air inlet duct assembly can in particular be composed of a plurality of air inlet ducts which transition in each case directly to air outlet ducts. For example, a first air inlet duct assembly can transition to a first air outlet duct assembly, a second air inlet duct assembly can transition to a second air outlet duct assembly, a third air inlet duct assembly can transition to a third air outlet duct assembly. In this case, an air distributor region could be obsolete.

The spray gun according to the invention preferably has at least one device for entering and/or detecting and/or adjusting and/or displaying at least one parameter of at least one fluid flowing through the spray gun, in particular a pressure, temperature, moisture, a volumetric flow, a viscosity and/or a flow rate. The fluid is preferably air and/or at least one spray medium. In the present case, powders can also be considered to be a fluid.

A device for detecting at least one parameter can be designed as, for example, a pressure sensor, a thermometer or temperature probes, respectively, a flow rate sensor or flow rate meter, respectively, in particular functioning by means of an impeller, vortex or ultrasound and/or thermal flow rate sensors, flow meters or anemometers.

A device for adjusting at least one parameter can in particular be designed as an actuator, for example as a valve, aperture or similar. The value of the parameter can be changed by means of the device for adjusting at least one parameter.

A device for displaying at least one parameter can be connected wirelessly or by wire to a device for detecting at least one parameter, so that the value detected by the device for detecting a parameter can be displayed, ideally in real time, by the device for displaying a parameter. The device for displaying at least one parameter can be disposed within or on the spray gun; the device for displaying at least one parameter or a further device for displaying at least one parameter, can however also be disposed outside the spray gun. The device for displaying at least one parameter can be designed as an analog display, for example as part of an analog manometer, or as a digital display, for example as a screen or a display, or have components of this type. The device for displaying at least one parameter is particularly preferably an LCD or OLED display.

The device for entering at least one parameter of at least one fluid flowing through the spray gun can serve for establishing a specific target value for this parameter, in particular one or a plurality of the above-mentioned parameters, or for communicating said target value to a control and/or feedback-control device, respectively. The device for entering can be designed as, for example, a keyboard, a touch display, a rotary button, an array of buttons, a selector lever, or have means of such type. The device for entering at least one parameter can be disposed within or on the spray gun; the device for entering at least one parameter or a further device for entering at least one parameter can however also be disposed outside the spray gun.

The communication between the device for entering at least one parameter, the device for detecting a parameter, the device for adjusting a parameter and/or the device for displaying an parameter can take place, for example, by means of cables or wires or wirelessly, for example by radio, satellite, Bluetooth, WLAN, ZigBee, NFC, Wibree, WiMAX, LoRaWAN and/or IrDA.

One particularly preferred exemplary embodiment of the spray gun according to the invention has at least one separate first control and/or feedback-control device, in particular for controlling and/or feedback-controlling at least one parameter, in particular a pressure, a volumetric flow and/or a flow rate, of the air flowing through the first air outlet duct assembly, at least one separate second control and/or feedback-control device, in particular for controlling and/or feedback-controlling at least one parameter, in particular a pressure, a volumetric flow and/or a flow rate, of the air flowing through the second air outlet duct assembly, and at least one separate third control and/or feedback-control device, in particular for controlling and/or feedback-controlling at least one parameter, in particular a pressure, a volumetric flow and/or a flow rate, of the air flowing through the third air outlet duct assembly. Separate in this context means that said devices at least do not form any module. However, said devices can be designed in such a manner that said devices communicate with one another directly or indirectly, in particular by way of a data processing device. The first, the second and the third control and/or feedback-control device can in each case be wirelessly or by wire connected to a separate device for displaying at least one parameter, in particular a device for displaying at least one parameter described above. However, the control and/or feedback-control devices can also be connected wirelessly or by wire to a common device for displaying at least one parameter, in particular a device for displaying at least one parameter described above. Said devices are particularly preferably connected to one or a plurality of devices for detecting at least one parameter, in particular to one or a plurality of the devices for detecting at least one parameter of at least one fluid flowing through the spray gun, in particular a pressure, temperature, moisture, a volumetric flow, a viscosity and/or a flow rate, as described above. As has already been mentioned above, the spray gun according to the invention is particularly preferably designed in such a manner that at least one parameter of the air flowing through the first air outlet duct assembly, and at least one parameter of the air flowing through the second air outlet duct assembly, and at least one parameter of the air flowing through the third air outlet duct assembly are able to be controlled and/or feedback-controlled in a mutually independent manner, wherein the mentioned parameters can in particular be a pressure, a volumetric flow and/or a flow rate. The control and/or feedback-control devices mentioned are expedient for this purpose.

The spray gun according to the invention can preferably be designed in such a manner that said spray gun has at least one first control and/or feedback-control device, in particular for controlling and/or feedback-controlling at least one parameter, in particular a pressure, a volumetric flow and/or a flow rate, of the air flowing through the first air outlet duct assembly, at least one second control and/or feedback-control device, in particular for controlling and/or feedback-controlling at least one parameter, in particular a pressure, a volumetric flow and/or a flow rate, of the air flowing through the second air outlet duct assembly, and at least one third control and/or feedback-control device, in particular for controlling and/or feedback-controlling at least one parameter, in particular a pressure, a volumetric flow and/or a flow rate, of the air flowing through the third air outlet duct assembly, wherein at least two, preferably three, of the devices are designed as a module. The control and/or feedback-control devices designed as a module can share a common housing and/or common power supply, for example, or have any other manifestation of a module.

The spray gun according to the invention preferably has at least one air chamber which is particularly preferably disposed in an air distributor region proceeding from which the first air outlet duct assembly, the second air outlet duct assembly and/or the third air outlet duct assembly extend. The air chamber can also be designed as an air distributor region. An air inlet duct, in particular an air inlet duct described above, can extend from the air connector of the spray gun to the air chamber, wherein the air chamber is a cavity, preferably within the spray gun, in particular within the main body of the spray gun. The first air outlet duct assembly, the second air outlet duct assembly and/or the third air outlet duct assembly, preferably all three air outlet duct assemblies, extend/extends so as to proceed from the air chamber. The air chamber, like the air distributor region, can also be formed by a plurality of different components of the spray gun, for example by the main body of the spray gun conjointly with an add-on part or a cover. The air chamber can particularly preferably be a buffer chamber for storing air at a constant pressure.

The spray gun furthermore preferably has at least one air chamber control and/or feedback-control device for controlling and/or feedback-controlling the air pressure prevalent in an air chamber within the spray gun. The air chamber is particularly preferably the air chamber just described. “Within the spray gun” preferably means that the air chamber is disposed within the main body of the spray gun; however, this can also mean that the air chamber, as has already been mentioned above, is formed by a plurality of different components of the spray gun, for example by the main body of the spray gun conjointly with an add-on part or a cover. For example, the pressure within the air chamber, by means of the device for controlling and/or feedback-controlling the air pressure prevalent in an air chamber within the spray gun, can be kept constant, preferably at an adjustable value or range of values, so that the air chamber can fulfil its purpose as a buffer chamber. As a result, it can be guaranteed that the air flows in the air outlet duct assemblies, in particular the parameters such as, for example, the pressure, the volumetric flow and/or the flow rate, of the air flowing through the first, the second of the third air outlet duct assembly, can be kept constant. In an analogous manner, parameters of the air flowing from the first, the second and the third air outlet opening can also be kept constant, as a result of which a constant spray jet can be generated. The air chamber control and/or feedback-control device in the simplest case can be a simple mechanical adjustment element, for example an actuating element known from the prior art, an aperture, a screw, an air micrometer, or similar. However, the air chamber control and/or feedback-control device can also comprise a complete control loop, in which a target value for the air pressure prevalent in the air chamber is entered, and actual value for the air pressure prevalent in the air chamber is determined, the actual value is compared with a target value, and the actual value of the air pressure prevalent in the air chamber is thereupon aligned with the target value, in particular by way of at least one actuator, for example by way of an actuating element known from the prior art, an aperture, a screw, a valve or similar.

The first air outlet duct assembly preferably opens into a first air outlet opening of a substantially annular design, the second air outlet duct assembly opens into a second air outlet opening of a substantially annular design, and/or the third air outlet duct assembly opens into a third air outlet opening of a substantially annular design. The rings can be disposed in a mutually concentric manner, but may also be disposed in an offset manner and at different positions of the spray gun. The explanations above pertaining to air impacting the material to be sprayed and exiting from the material nozzle upon the air exiting from the first, the second and the third air outlet duct assembly can apply in analogous manner here.

It can be provided that the air flowing through the first air outlet duct assembly, the air flowing through the second air outlet duct assembly and/or the air flowing through the third air outlet duct assembly can be temperature-controlled. To this end, at least one heating and/or cooling element can in each case be disposed in the first air outlet duct assembly, in the second air outlet duct assembly and/or in the third air outlet duct assembly, for example. Alternatively or additionally, the at least one heating and/or cooling element can be disposed at another location of the spray gun, for example at the air connector. Changing the viscosity of the material to be sprayed can be made possible by temperature-controlling the air. The drying time of the sprayed material on the coated object can be reduced by heating the air.

It can furthermore be provided that the air flowing through the first air outlet duct assembly, the air flowing through the second air outlet duct assembly and/or the air flowing through the third air outlet duct assembly can be ionized. To this end, at least one device for ionization can in each case be disposed in the first air outlet duct assembly, in the second air outlet duct assembly and/or in the third air outlet duct assembly, for example. It can be provided that a positive or a negative charge is set. Inclusions of dust in the paint layer can in particular be reduced or avoided by ionizing the air.

Alternatively or additionally to the parameters mentioned above, the at least one parameter of the air flowing through the first air outlet duct assembly and/or the at least one parameter of the air flowing through the second air outlet duct assembly and/or the at least one parameter of the air flowing through the third air outlet duct assembly, said parameters being able to be controlled and/or feedback-controlled in a mutually independent manner, can be a temperature and/or a degree of ionization.

The term “air” is presently to be understood mean any type of gas or a gas mixture, in particular also nitrogen.

The invention will be explained in more detail in an exemplary manner hereunder by means of four figures in which:

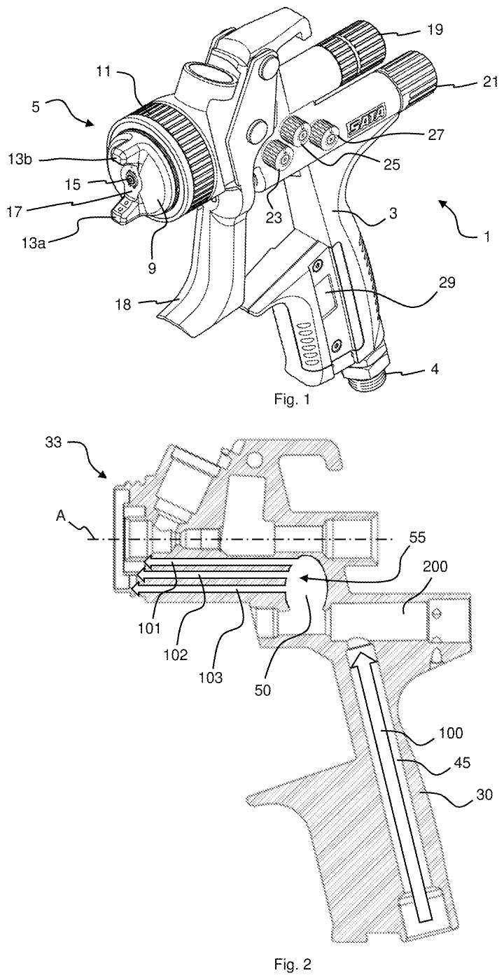

FIG. 1 shows a perspective view of an exemplary embodiment of a spray gun according to the invention;

FIG. 2 shows a sectional view of the main body of an exemplary embodiment of a spray gun according to the invention, including a schematic illustration of flow paths;

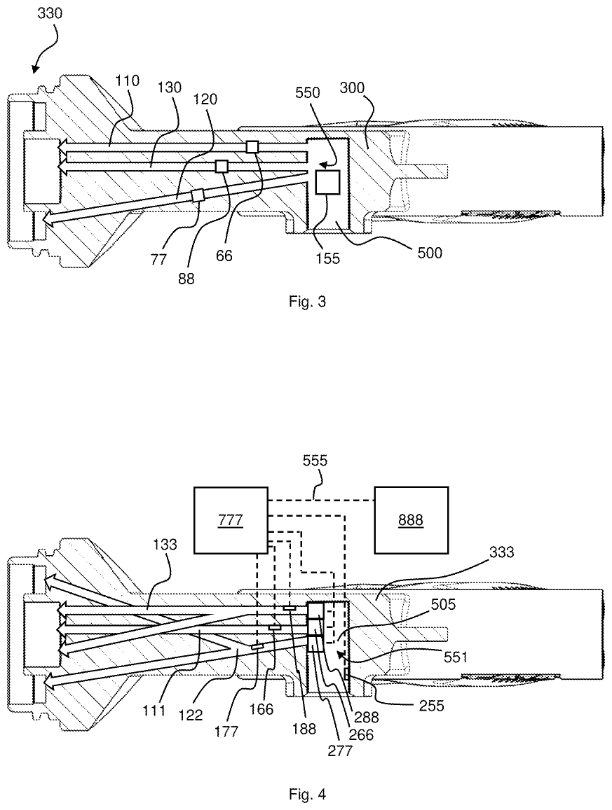

FIG. 3 shows a sectional view of the main body of a further exemplary embodiment of a spray gun according to the invention, including a schematic illustration of flow paths; and

FIG. 4 shows a sectional view of the main body of a further exemplary embodiment of a spray gun according to the invention, including a schematic illustration of flow paths as well as signal transmission paths and/or data transmission paths.

FIG. 1 shows a perspective view of an exemplary embodiment of a spray gun 1 according to the invention, having a main body 3 on the lower end of which is disposed an air connector 4. The spray gun 1 furthermore has an air nozzle 5 which presently comprises an air cap 9 which by means of an air nozzle ring 11 is screwed to the main body 3 of the spray gun 1. The air cap 9 in the exemplary embodiment shown has two horns 13a, 13b having in each case to horn air openings. Moreover, said air cap 9 possesses a central opening 15 which, conjointly with a material nozzle screwed into the main body 3, presently forms an annular gap. A plurality of control openings 17 are in each case incorporated on two mutually opposite sides of the central opening 15, so as to be next to the central opening 15. A material quantity control which is able to be activated by way of a material quantity rotary control button 19 is disposed in the spray gun 1. A rear detent for a paint nozzle is able to be defined by way of the material quantity control, i.e. it can be adjusted by way of the material quantity control how far the paint needle can exit from the material outlet opening of the material nozzle when the trigger 18 is activated. As a result, the maximum flow cross section for the material flowing from the material outlet opening of the material nozzle, and thus the quantity of the material sprayed by the spray gun 1, is defined.

The spray gun 1 moreover has a device by way of which the quantity of air which from an air inlet duct assembly, which is not visible in FIG. 1 and from the air connector 4 extends upward through the handle of the spray gun 1, flows into an upper part of the gun body 3 is able to be adjusted. To this end, a so-called air micrometer may be used, the latter presently being able to be activated by means of an air micrometer rotary button 21. The air micrometer can be designed, for example, as a sleeve which in the wall thereof has an opening, the degree of overlap of the latter with the port of the air inlet duct assembly being adjustable. The flow cross section through which the air from the handle region of the spray gun 1 can flow into an upper part of the gun body 3 is able to be adjusted in this way.

The present exemplary embodiment of a spray gun according to the invention in the interior thereof has a first air outlet duct assembly, not visible in FIG. 1, a second air inlet duct assembly, likewise not visible in FIG. 1, and a third air outlet duct assembly, likewise not visible in FIG. 1, wherein at least one parameter, in particular a pressure, a volumetric flow and/or a flow rate, of the air flowing through the first air outlet duct assembly, at least one parameter, in particular a pressure, a volumetric flow and/or a flow rate, of the air flowing through the second air outlet duct assembly, and at least one parameter, in particular a pressure, a volumetric flow and/or a flow rate, of the air flowing through the third air outlet duct assembly, are able to be controlled in a mutually independent manner. A first rotary control button 23 for activating a control device for controlling at least one parameter of the air flowing through the first air outlet duct assembly, a second rotary control button 25 for activating a control device for controlling at least one parameter of the air flowing through the second air outlet duct assembly, and a third rotary control button 27 for activating a control device for controlling at least one parameter of the air flowing through the third air outlet duct assembly can be seen in FIG. 1.

The air flowing through the first air outlet duct assembly can be utilized as atomization air, i.e. for atomizing a spray medium, and flow out of the annular gap formed by the central opening 15 and the material nozzle screwed into the main body 3. The air flowing through the second air outlet duct assembly can be utilized as forming air. i.e. for changing the shape of a spray jet, and flow out of the horn air openings of the horns 13a, 13b. The air flowing through the third air outlet duct assembly can be utilized as transport air, i.e. for transporting an atomized spray medium away from the spray gun, and flow out of the control opening 17.

The spray gun 1 moreover has a device for detecting and displaying at least one parameter of at least one fluid flowing through the spray gun, said device having a display 29. A device of this type in all exemplary embodiments of the spray gun according to the invention preferably serves for detecting and/or displaying a parameter of air flowing through the spray gun 1, particularly preferably of different types of air; a device of this type serves in particular for detecting and/or displaying the pressure and/or the volumetric flow of the air flowing into the gun, the pressure and/or the volumetric flow of the air flowing through the first air outlet duct assembly, the pressure and/or the volumetric flow of the air flowing through the second air outlet duct assembly, and/or the pressure and/or the volumetric flow of the air flowing through the third air outlet duct assembly.

FIG. 2 shows a sectional view of the main body 30 of an exemplary embodiment of a spray gun according to the invention, including a schematic illustration of flow paths. The air inlet duct assembly 45 can be seen in particular. The air inlet arrow 100 schematically shows the flow of the air flowing into the spray gun, or into the main body 30, respectively. An air micrometer receptacle bore 200 is incorporated in the main body 30 so as to be downstream of the air inlet duct assembly 45. The air micrometer receptacle bore 200 presently extends in a manner substantially parallel to a material outlet axis A and serves for receiving a control and/or feedback-control device which preferably controls or feedback-controls, respectively, air quantity, i.e. the volumetric flow that flows from the air inlet duct assembly 45 into an air chamber 50. This control and/or feedback-control device can be, for example, a conventional air micrometer, a feedback-controllable air micrometer or a similar device. The control and/or feedback-control device can be designed as a device for controlling and/or feedback-controlling the air pressure prevalent in an air chamber 50. An air distributor region 55 is disposed in the air chamber 50, or vice versa, the air chamber 50 forms an air distributor region 55, respectively. The air chamber 50 in the present exemplary embodiment as well as in all other exemplary embodiments advantageously acts as a buffer chamber for air in which a consistent air pressure is prevalent, in particular thanks to the device for controlling and/or feedback-controlling the air pressure prevalent in an air chamber 50.

A first air outlet duct assembly 101, indicated only schematically as a flow arrow, a second air outlet duct assembly 102, likewise indicated only schematically as a flow arrow, and a third air outlet duct assembly 103, likewise indicated only schematically as a flow arrow, extend so as to proceed from the air distributor region 55. The flow arrows indicate merely the potential approximate profile of the first air outlet duct assembly 101, the second air outlet duct assembly 102 and the third air outlet duct assembly 103 from the air distributor region 55 in the direction of the head region 33 of the main body 30. The exact profile, including the start and the end, the shape, the arrangement and the number of the first air outlet duct assembly 101, of the second air outlet duct assembly 102 and of the third air outlet duct assembly 103 can in particular differ from the illustration in the figures, in particular in FIG. 2.

The first air outlet duct assembly 101 is preferably designed for guiding atomization air, i.e. said first air outlet duct assembly 101 is designed in such a manner that a spray medium is able to be atomized by means of the air guided by said first air outlet duct assembly 101. The second air outlet duct assembly 102 is preferably designed for guiding forming air, i.e. said second air outlet duct assembly 102 is designed in such a manner that the shape of the spray jet is able to be changed by means of the air guided by said second air outlet duct assembly 102. The third air outlet duct assembly 103 is preferably designed for guiding transport air, i.e. said third air outlet duct assembly 103 is designed in such a manner that an atomized spray medium is able to be moved away from the spray gun by means of the air guided by said third air outlet duct assembly 103.

FIG. 3 shows a sectional view of the main body 300 of a further exemplary embodiment of a spray gun according to the invention, including a schematic illustration of flow paths. In a manner similar to the exemplary embodiment shown in FIG. 2, the exemplary embodiment shown in FIG. 3 also has an air chamber 500 and an air distributor region 550. A first air outlet duct assembly 110, again indicated only schematically as a flow arrow, a second air outlet duct assembly 120, likewise indicated only schematically as a flow arrow, and a third air outlet duct assembly 130, likewise indicated only schematically as a flow arrow, extends so as to proceed from said air distributor region 550. Here too, the flow arrows indicate merely the potential approximate profile of the first air outlet duct assembly 110, the second air outlet duct assembly 120 and the third air outlet duct assembly 130 from the air distributor region 550 in the direction of the head region of 330 of the main body 300. The exact profile, including the start and the end, the shape, the arrangement and the number of the first air outlet duct assembly 110, of the second air outlet duct assembly 120 and of the third air outlet duct assembly 130 can differ from the illustration in the figures, in particular in FIG. 3.

Here too, the first air outlet duct assembly 110 is preferably designed for guiding atomization air, i.e. said first air outlet duct assembly 110 is designed in such a manner that a spray medium is able to be atomized by means of the air guided by said first air outlet duct assembly 110, the second air outlet duct assembly 120 is preferably designed for guiding forming air, i.e. said second air outlet duct assembly 120 is designed in such a manner that the shape of a spray jet is able to be changed by means of the air guided by said second air outlet duct assembly 120, and the third air outlet duct assembly 130 is preferably designed for guiding transport air, i.e. said third air outlet duct assembly 130 is designed in such a manner that an atomized spray medium is able to be moved away from the spray gun by means of the air guided by said third air outlet duct assembly 130.

The exemplary embodiment of a spray gun according to the invention shown in FIG. 3 has a separate first control and/or feedback-control device 66 for controlling and/or feedback-controlling at least one parameter, in particular a pressure, a volumetric flow and/or a flow rate, of the air flowing through the first air outlet duct assembly 110, a separate second control and/or feedback-control device 77 for controlling and/or feedback-controlling at least one parameter, in particular a pressure, a volumetric flow and/or a flow rate, of the air flowing through the second air outlet duct assembly 120, and a separate third control and/or feedback-control device 88 for controlling and/or feedback-controlling at least one parameter, in particular a pressure, a volumetric flow and/or a flow rate, of the air flowing through the third air outlet duct assembly 130.

The first control and/or feedback-control device 66, the second control and/or feedback-control device 77 and the third control and/or feedback-control device 88 in the simplest case can be simple mechanical adjustment elements, for example actuating elements known from the prior art, apertures, screws or similar which are able to be activated, for example by way of rotary buttons which can be designed like the first rotary control button 23, the second rotary control button 25 and the third rotary control button 27, for example, so as to be able to adjust the parameter, or the parameters, respectively, of the air flowing through the first air outlet duct assembly 110, the air flowing through the second air outlet duct assembly 120, and/or the air flowing through the third outlet duct assembly 130. A device for detecting the parameter does not necessarily have to be provided. The adjustment can also take place according to the intuition of the user of the spray gun.

The first control and/or feedback-control device 66, the second control and/or feedback-control device 77 and the third control and/or feedback-control device 88 can however also comprise a complete control loop in which a target value for at least one parameter is entered, an actual value for the parameter is determined, the actual value is compared with the target value, and the actual value of the parameter is thereupon aligned with the target value, in particular by way of at least one actuator, for example by way of an actuating elements known from the prior art, an aperture, a screw, a valve or similar.

The first control and/or feedback-control device 66, the second control and/or feedback-control device 77 and the third control and/or feedback-control device 88 can be present in all exemplary embodiments of the spray gun according to the invention and/or in all exemplary embodiments of the spray gun according to the invention can have a device for entering and/or detecting and/or displaying at least one parameter of at least one fluid flowing through the spray gun, in particular a pressure, temperature, a moisture, a volumetric flow, a viscosity and/or a flow rate, or be connected to a device of this type.

FIG. 4 shows a sectional view of the main body 333 of a further exemplary embodiment of a spray gun according to the invention, including a schematic illustration of flow paths as well as signal paths and/or data transmission paths. The main body 333 has an air chamber 505, an air distributor region 551, a first air outlet duct assembly 111, again indicated only schematically as a flow arrow, a second air outlet duct assembly 122, likewise indicated only schematically as a flow arrow, and a third air outlet duct assembly 133, likewise indicated only schematically as a flow arrow.

Here too, the first air outlet duct assembly 111 is preferably designed for guiding atomization air, i.e. said first air outlet duct assembly 101 is designed in such a manner that a spray medium is able to be atomized by means of the air guided by said first air outlet duct assembly 111, the second air outlet duct assembly 122 is preferably designed for guiding forming air, i.e. said second air outlet duct assembly 122 is designed in such a manner that the shape of a spray jet is able to be changed by means of the air guided by said second air outlet duct assembly 122, and the third air outlet duct assembly 133 is preferably designed for guiding transport air, i.e. said third air outlet duct assembly 133 is designed in such a manner that an atomized spray medium is able to be moved away from the spray gun by means of the air guided by said third air outlet duct assembly 133.

The second air outlet duct assembly 122 and the third air outlet duct assembly 133 separate in the present exemplary embodiment, which may also be the case in all other exemplary embodiments. The spray gun in the present case has a feedback-control device for feedback-controlling at least one parameter, in particular a pressure, a volumetric flow and/or a flow rate, of the air flowing through the first air outlet duct assembly 111, through the second air outlet duct assembly 122 and through the third air outlet duct assembly 133. The feedback-control device is disposed in part in the air chamber 505, or in the air distributor region 551, respectively, in part in the first air outlet duct assembly 111, the second air outlet duct assembly 122 and the third air outlet duct assembly 133, and in part outside the spray gun. The feedback-control device comprises in particular a first device 166 for detecting a parameter of the air flowing through the first air outlet duct assembly 111, a second device 177 for detecting a parameter of the air flowing through the second air outlet duct assembly 122, a third device 188 for detecting a parameter of the air flowing through the third air outlet duct assembly 133, a feedback-controller 777 which can also be designed as a data processing device or be part of a data processing device, a device 888 for displaying a parameter, which likewise can be part of a data processing device, a first actuator 266, a second actuator 277, and a third actuator 288. The spray gun can furthermore have a fourth device 255 for detecting a parameter, in particular the pressure prevalent within the air chamber 505. Moreover, said spray gun can have a device for entering a parameter, or be connected to such a device. The device for entering a parameter can be part of a data processing device, for example of a PC or of a mobile phone. The different components can be connected to one another in a communicating manner by cable and/or wirelessly. The signal and/or data transmission link 555 illustrated with dashed lines for reasons of clarity is presently provided with a reference sign as the only signal and/or data transmission link. The other dashed lines presently are likewise wired and/or wireless signal and/or data transmission links. This combination and arrangement of a feedback-control device, or the components thereof, respectively, can be present in all exemplary embodiments of the spray gun according to the invention.

In all exemplary embodiments of the spray gun according to the invention it is possible for at least one parameter, in particular a pressure, a volumetric flow and/or a flow rate, of the air flowing through the first air outlet duct assembly 101, 110, 111, at least one parameter, in particular a pressure, a volumetric flow and/or a flow rate of the air flowing through the second air outlet duct assembly 102, 120, 122, and at least one parameter, in particular a pressure, a volumetric flow and/or a flow rate, of the air flowing through the third air outlet duct assembly 103, 130, 133 to be adjusted, in particular to be controlled and/or feedback-controlled in a mutually independent manner.

In this way it is possible, for example, to set a pressure of 0.7 bar for the atomization air flowing through the first air outlet duct assembly 101, 110, 111, a pressure of 0.6 bar for the forming air flowing through the second air outlet duct assembly 102, 120, 122, and a pressure of 0.3 bar for the transport air flowing through the third air outlet duct assembly 103, 130, 133. The value of the parameter can be measured, for example, in the respective air outlet duct assembly or in an air nozzle 5, shown in FIG. 1, close to a first air outlet opening into which the first air outlet duct assembly 101, 110, 111 opens, or close to a second air outlet opening into which the second air outlet duct assembly 102, 120, 122 opens, or close to a third air outlet opening into which the third air outlet duct assembly 103, 130, 133 opens, respectively.

With reference to the exemplary embodiment from FIG. 4, the user of the spray gun, by means of a device for entering a parameter, can for example communicate a desired target value for a parameter of the through the first air outlet duct assembly 111, the desired target value for a parameter of the through the second air outlet duct assembly 122, and a desired target value for a parameter of the through the third air outlet duct assembly 133 to the spray gun, or to the feedback-control device, in particular to the feedback-controller 777, in particular enter the target value. The first device 166 for detecting a parameter of the air flowing through the first air outlet duct assembly 111, the second device 177 for detecting a parameter of the air flowing through the second air outlet duct assembly 122, and the third device 188 for detecting a parameter of the air flowing through the third air outlet duct assembly 133 determines the actual value of the parameter and communicates the latter to the feedback-control device, in particular to the feedback-controller 777. In the event of a variance between the target value and the actual value, the feedback-controller 777 activates the first actuator 266, the second actuator 277, or the third actuator 288, respectively, as required, whereupon for example more or less air flows from the air chamber 505 into the first air outlet duct assembly 111, into the second air outlet duct assembly 122, or into the third air outlet duct assembly 133, respectively. The desired target value for the parameter is also maintained when the target value and thereupon the actual value for the parameter is changed in another air outlet duct assembly, and/or also when pressure variations are present at the gun inlet. The fourth device 255 for detecting a parameter, in particular the pressure prevalent within the air chamber 505, likewise reports the determined actual value to the feedback-controller 777 which compares said actual value with a target value which can likewise be specified by the user of the spray gun, and if required activates an actuator, for example at the gun inlet or at the compressor, so as to increase or reduce the air supply to the gun, respectively.

In general, the components mentioned individually in the exemplary embodiments can be used in all exemplary embodiments. The explanations pertaining to the exemplary embodiments can also apply to all exemplary embodiments.

The described exemplary embodiments describe only a limited selection of potential embodiments and thus do not represent any limitation of the present invention.

1-15. (canceled)

16. A spray gun having at least one first air outlet duct assembly and at least one second air outlet duct assembly, wherein at least one of a pressure, a volumetric flow and a flow rate, of air flowing through the at least one first air outlet duct assembly and at least one of a pressure, a volumetric flow and a flow rate, of air flowing through the at least one second air outlet duct assembly are controllable in a mutually independent manner, wherein the spray gun has at least one third air outlet duct assembly, and wherein at least one of a pressure, a volumetric flow and/or a flow rate of air flowing through the at least one third air outlet duct assembly is controllable independently of at least one of the pressure, the volumetric flow and the flow rate, of the air flowing through the at least one first air outlet duct assembly and/or independently of at least one of the pressure, the volumetric flow and/or the flow rate, of the air flowing through the at least one second air outlet duct assembly.

17. The spray gun of claim 16, wherein the at least one first air outlet duct assembly is designed such that a spray medium is able to be atomized by means of the air guided by the at least one first air outlet duct assembly, wherein the at least one second air outlet duct assembly is designed such that a shape of a spray jet is able to be changed by means of the air guided by the at least one second air outlet duct assembly, and/or wherein the at least one third air outlet duct assembly is designed such that an atomized spray medium is able to be moved away from the spray gun by means of the air guided by the at least one third air outlet duct assembly.

18. The spray gun of claim 16, wherein the spray gun has a material nozzle having a material outlet opening for delivering material to be sprayed, and an air cap having a central opening and two horns each having at least one horn air opening, wherein an outer wall of the material nozzle, conjointly with the region of the air cap that delimits the central opening of the air cap, forms an annular gap, and wherein the air cap on at least two mutually opposite sides of the central opening, next to the central opening, has in each case at least one control opening, wherein a spray medium is able to be atomized by means of the air flowing from the annular gap, wherein the shape of a spray jet is able to be changed by means of the air flowing from the horns, and wherein an atomized spray medium is able to be moved away from the spray gun by means of the air flowing from the control openings.

19. The spray gun of claim 16, wherein the spray gun has a material nozzle having a material outlet opening for delivering material to be sprayed, and a material outlet axis along which the material to be sprayed flows out, and wherein the spray gun is designed such that air for atomizing a spray medium upon exiting the at least one first air outlet duct assembly impacts the material to be sprayed and exiting the material nozzle in a manner substantially parallel to the material outlet axis and/or obliquely, wherein air for shaping a spray jet upon exiting the at least one second air outlet duct assembly impacts the atomized material obliquely, and wherein air for transporting the atomized material in the direction of an object to be coated upon exiting the at least one third air outlet duct assembly impacts the atomized material in a manner substantially parallel to the material outlet axis.

20. The spray gun of claim 16, wherein the controlling of at least one of the pressure, the volumetric flow and the flow rate, of the air flowing through the at least one first air outlet duct assembly takes place by means of a first control device disposed in the at least one first air outlet duct assembly and/or in an air distributor region, wherein the controlling of at least one of the pressure, the volumetric flow and the flow rate, of the air flowing through the at least one second air outlet duct assembly takes place by means of a second control device disposed in the at least one second air outlet duct assembly and/or in the air distributor region, and/or wherein the controlling of at least one of the pressure, the volumetric flow and the flow rate, of the air flowing through the at least one third air outlet duct assembly takes place by means of a third control device disposed in the at least one third air outlet duct assembly and/or in the air distributor region.

21. The spray gun of claim 16, wherein the at least one first air outlet duct assembly opens into at least one first air outlet opening, wherein the at least one second air outlet duct assembly opens into at least one second air outlet opening, and wherein the at least one third air outlet duct assembly opens into at least one third air outlet opening.

22. The spray gun of claim 16, wherein the spray gun has a main body having a head region, wherein the head region has at least one first air outlet opening, at least one second air outlet opening and/or at least one third air outlet opening.

23. The spray gun of claim 16, wherein the spray gun has at least one nozzle assembly having at least one air nozzle, wherein the at least one air nozzle has at least one first air outlet opening designed as a central opening in an air cap of the at least one air nozzle, at least one second air outlet opening designed as a horn air opening incorporated in horns on the air cap of the at least one air nozzle, and/or at least one third air outlet opening designed as a control opening in the air cap.

24. The spray gun of claim 16, wherein the spray gun has at least one air connector at least one air inlet duct assembly and at least one air distributor region, wherein the at least one air inlet duct assembly extends from the at least one air connector to the at least one air distributor region, wherein the at least one first air outlet duct assembly extends from the at least one air distributor region to at least one first air outlet opening, wherein the at least one second air outlet duct assembly extends from the at least one air distributor region to at least one second air outlet opening, wherein the at least one third air outlet duct assembly extends from the at least one air distributor region to at least one third air outlet opening, and wherein the at least one first air outlet duct assembly, the at least one second air outlet duct assembly and the at least one third air outlet duct assembly are mutually separated in spatial terms.

25. The spray gun of claim 16, wherein the spray gun has at least one device for entering, detecting, adjusting, and/or displaying a parameter of at least one fluid flowing through the spray gun, and wherein the parameter is at least one of pressure, temperature, moisture, volumetric flow, viscosity and flow rate.

26. The spray gun of claim 16, wherein the spray gun has at least one separate first control device for controlling at least one of the pressure, the volumetric flow and the flow rate, of the air flowing through the at least one first air outlet duct assembly, at least one separate second control device for controlling at least one of the pressure, the volumetric flow and the flow rate, of the air flowing through the at least one second air outlet duct assembly, and at least one separate third control device for controlling at least one of the pressure, the volumetric flow and the flow rate, of the air flowing through the at least one third air outlet duct assembly.

27. The spray gun of claim 16, wherein the spray gun has at least one first control device for controlling at least one of the pressure, the volumetric flow and the flow rate, of the air flowing through the at least one first air outlet duct assembly, at least one second control device for controlling at least one of the pressure, the volumetric flow and the flow rate, of the air flowing through the at least one second air outlet duct assembly, and at least one third control device for controlling at least one of the pressure, the volumetric flow and the flow rate, of the air flowing through the at least one third air outlet duct assembly, wherein at least two of the first, second, and third control devices are designed as a module.

28. The spray gun of claim 16, wherein the spray gun has at least one air chamber proceeding from which the at least one first air outlet duct assembly, the at least one second air outlet duct assembly and/or the at least one third air outlet duct assembly extend.

29. The spray gun of claim 16, wherein the spray gun has at least one air chamber control and/or feedback-control device for controlling and/or feedback-controlling the air pressure prevalent in an air chamber within the spray gun.

30. The spray gun of claim 16, wherein the first air outlet duct assembly opens into a first air outlet opening of a substantially annular design, wherein the second air outlet duct assembly opens into a second air outlet opening of a substantially annular design, and/or wherein the third air outlet duct assembly opens into a third air outlet opening of a substantially annular design.
